(19) United States
(12) Patent Application Publication
(10) Pub. No.: US 2005/0128419 A1
(43) Pub. Date: Jun. 16, 2005

(54) Dispenser for liquid crystal display panel

(76) Inventors: Soo-Min Kwak, Gumi (KR); Se-Joon Baek, Dongrae-Gu (KR)

Correspondence Address: MCKENNA LONG & ALDRIDGE LLP, 1900 K STREET, NW, WASHINGTON, DC, 20006, US

(21) Appl. No.: 10/995,543

(22) Filed: Nov. 24, 2004

(30) Foreign Application Priority Data
Nov. 25, 2003 (KR) 2003-84165

(51) Int. Cl. G02F 1/1339

(52) U.S. Cl. 349/153

(57) ABSTRACT

A sealant dispenser includes at least one syringe that contains sealant, a nozzle in fluid communication with the at least one syringe, wherein sealant contained by the syringe is dispensable onto a substrate through a lower portion of the nozzle and accumulatable at the lower portion of the nozzle, and at least one cleaning unit that, when operably proximate to the lower portion of the nozzle, removes residual sealant accumulated at the lower portion of the nozzle.

This application claims the benefit of Korean Patent Application No. 84165/2003, filed on Nov. 25, 2003, which is hereby incorporated by reference for all purposes as if fully set forth herein.

### BACKGROUND OF THE INVENTION

1. Field of the Invention

The present invention generally relates to sealant dispensers. More particularly, the present invention relates to a sealant dispenser having a syringe with a nozzle and a means for removing residual sealant accumulated at the end of the nozzle.

2. Discussion of the Related Art

Generally, LCD devices display images by controlling light transmittance characteristics of an array of pixels in accordance with exterior data signals. Accordingly, LCD devices include an LCD panel, on which the pixels are arranged in a matrix pattern, and a driving circuit for driving the pixels.

A LCD panel includes a color filter substrate bonded to, and spaced apart from, a thin film transistor array substrate to form a uniform cell-gap that contains a liquid crystal layer. The driving circuit includes a gate driving integrated circuit and a data driving integrated circuit that supplies scan and data signals, respectively, to the pixels of the LCD panel.

The thin film transistor array substrate includes a plurality of data lines, a plurality of gate lines orthogonally crossing the data lines to define the array of pixels. Each pixel is provided with a thin film transistor connected to a gate and data line and a pixel electrode connected to a corresponding thin film transistor. Moreover, each data line is electrically connected to the data driving integrated circuit and each gate line is electrically connected to the gate driving integrated circuit.

The color filter substrate includes a common electrode that opposes the pixel electrodes of the thin film transistor array substrate.

The gate driving integrated circuit sequentially supplies a scan signal to the plurality of gate lines while the data driving integrated circuit simultaneously supplies data signals to the plurality of data lines. In response to a scan signal transmitted by a selected gate line to which the scan signal has been supplied, thin film transistors connected to the selected gate line switch data signals transmitted by, and supplied to, corresponding data lines to corresponding pixel electrodes. Thus, when a data signal is applied to a pixel electrode, and when a voltage is applied to the opposing common electrode, an electric field is generated within the liquid crystal layer provided therebetween. Due to anisotropic dielectric properties of molecules within the liquid crystal layer, liquid crystal molecules rotate in accordance with the generated electric field. As a result of the molecular rotation, the particular pixel in which the electric field is generated may either transmit light or prevent light from being transmitted, thereby displaying an image.

FIG. 1 illustrates a plan view of a related art LCD panel such as that described above.

Referring to FIG. 1, the related art LCD panel 100 includes an image display unit 113, on which the aforementioned array of pixels are formed; a gate pad portion 114 connected to gate lines of the image display unit 113; and a data pad portion 115 connected to data lines of the image display unit 113.

The gate and data pad portions 114 and 115, respectively, are arranged at edge regions of the thin film transistor array substrate 101 that are not overlapped by the color filter substrate 102. The gate pad portion 114 transmits the aforementioned scan signals, provided from the gate driver integrated circuit, to the gate lines of the image display unit 113. The data pad portion 115 supplies aforementioned data signals, provided from the data driver integrated circuit, to the data lines of the image display unit 113.

As shown in FIG. 1, the gate and data lines orthogonally cross each other on the thin film transistor array substrate 101 of the image display unit 113 to define pixels. Although not shown, however, each pixel is provided with a thin film transistor connected to a corresponding gate line and data line in addition to a pixel electrode connected to a corresponding thin film transistor. Further, a passivation layer (not shown) is formed over the entire surface of the thin film transistor array substrate 101 to protect the pixel electrodes and the thin film transistors.

The color filter substrate 102 of the image display unit 113 is provided with color filters (not shown) aligned with the aforementioned pixels, a black matrix (not shown) separating the color filters, and a common electrode formed of a transparent electrically conductive material and opposing the pixel electrodes formed on the thin film transistor array substrate 101.

The aforementioned thin film transistor array and color filter substrates 101 and 102, respectively, are bonded together via a seal pattern 116 formed at a peripheral edge of the image display unit 113. Bonded together, the thin film transistor array substrate 101 and the color filter substrate 102 define a cell-gap, the uniformity of which is maintained by spacers.

A method of fabricating LCD panels such as those described above, has been developed wherein a plurality of LCD panels are formed simultaneously from a single, large substrate (i.e., a base substrate) to increase the fabrication yield. According to this method, the base substrate must be cut to separate the plurality of LCD panels formed thereon. After the LCD panels are separated, liquid crystal material is injected into the cell-gap of each LCD panel via an injection hole formed in the seal pattern 116. After the cell-gap is completely filled with the liquid crystal material, the liquid crystal injection hole is sealed and the liquid crystal layer is thus formed.

The method of fabricating LCD panels as described above involves processes of fabricating a plurality of thin film transistor array substrates 101 on a first base substrate; fabricating a plurality of color filter substrates 102 on a second base substrate; forming the seal pattern 116 at peripheral edges of the image display unit 113 of the plurality of thin film transistor array substrates 101; bonding the first and second base substrates together via the seal pattern 116, wherein the thin film transistor array substrate 101 and the color filter substrate 102 are aligned, thereby forming the cell-gap; cutting the bonded first and second base substrates to separate the LCD panels formed thereon; and injecting liquid crystal material into each of the separated LCD panels.

FIGS. 2A and 2B illustrate a related art screen printing method used in forming seal patterns of LCD panels.

Referring to FIGS. 2A and 2B, the related art screen printing method incorporates a patterned screen mask 206 that exposes a seal pattern forming region of a substrate 200 and a squeegee 208 that supplies sealant 203 onto the seal pattern forming region exposed by the patterned screen mask 206 to form a seal pattern 216.

As shown in the Figures, the seal pattern 216 is formed along the edge of the image display unit 213 and includes a liquid crystal injection hole 204 defined at one side therein to facilitate the injection of liquid crystal material. The seal pattern 216 also prevents leakage of the injected liquid crystal outside the image display unit 213.

A related art screen printing method employed to form the aforementioned seal pattern 216 includes applying sealant 203 onto the patterned screen mask 206, forcing sealant 203 onto the seal pattern forming region of the substrate 200 by running the squeegee 208 over the patterned screen mask 206, and evaporating solvent within the sealant 203 on the substrate 200 to dry the sealant 203 into a level seal pattern 216.

The screen printing method discussed above is fairly straight-forward to apply to form seal patterns but can be disadvantageous because a relatively large amount of sealant 203 must be used to form a seal pattern 216 containing a relatively little amount of sealant 203. That is, a large amount of sealant 203 must be applied over the entire surface of the patterned screen mask 206 just to form the seal pattern 216 at peripheral areas of the image display unit 213. Moreover, because the patterned screen mask 206 contacts the substrate 200, the patterned screen mask 206 may deleteriously rub against an alignment layer (not shown) formed on the substrate 200, thereby causing a picture quality of the resultant LCD device to deteriorate. In an attempt to overcome the disadvantages discussed above, a seal dispensing method has been proposed.

FIG. 3 illustrates a related art seal dispensing method used in forming seal patterns of LCD panels.

Referring to FIG. 3, the seal dispensing method is effected by loading a substrate 300 onto a table 310 and moving the table 310 in left, right, forward, and reverse directions while applying a uniform pressure to a syringe 301 containing sealant. By moving the table 310 in a predetermined manner, the syringe 301 can dispense sealant from a nozzle to form a seal pattern 316 along peripheral edges of an image display unit 313.

As described above, the amount of sealant used to form the seal pattern is reduced compared to the related art screen printing method because the sealant is selectively applied to regions where the seal pattern 316 is to formed. Moreover, the picture quality of the resultant LCD device can be ensured because the syringe 301 does not contact an alignment film (not shown) formed on the image display unit 313.

Use of the related art seal dispensing method, however, may be disadvantageous because, as the sealant is dispensed from the nozzle to form seal patterns along peripheral edges of image display units, residual sealant accumulates at the nozzle. Therefore, an excessive amount of sealant is dispensed onto the substrate 300 at start points of sealant dispensing paths used in sequentially forming a plurality of sealant patterns 316. Subsequently, pressure used to bond the first and second base substrates together causes the excessively dispensed sealant to spread onto inner and outer sides of the image display units 313. Sealant that has spread onto the inner side of the image display unit 313 can contaminate liquid crystal material and degrade the picture quality of a subsequently formed LCD device. Thus, the presence of sealant on the inner side of the image display unit lowers the fabrication yield of the LCD device. Moreover, sealant that has spread onto the outer side of the image display unit can migrate into a cutting region where the first and second base substrates are cut to separate individual LCD panels. Thus, the presence of sealant within the cutting regions obstructs a cutting operation and lowers the productivity of fabricating the LCD device.

### SUMMARY OF THE INVENTION

Accordingly, the present invention is directed to a dispenser for a liquid crystal display panel that substantially obviates one or more of the problems due to limitations and disadvantages of the related art.

An advantage of the present invention provides a sealant dispenser which is capable of removing residual sealant accumulated at the end of a nozzle.

Another advantage of the present invention provides a sealant dispenser that substantially eliminates picture quality degradation caused by unacceptable spreading of sealant into an image display unit during a substrate bonding process, thereby improving the yield an LCD panel fabricating process.

Another advantage of the present invention provides a sealant dispenser that substantially eliminates cutting inefficiencies caused by unacceptable spreading of sealant outside an image display unit during a substrate bonding process, thereby improving the productivity of an LCD panel fabricating process.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a sealant dispenser includes a substrate having at least one image display unit; at least one syringe to supply a sealant to the substrate through a nozzle formed at its one end portion to form a seal pattern at an outer edge of the image display unit; and a cleaning unit to remove the sealant at the lower portion of the nozzle of the syringe.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a plan view of a related art LCD panel such as that described above;

FIGS. 2A and 2B illustrate a related art screen printing method used in forming seal patterns of LCD panels;

FIG. 3 illustrates a related art seal dispensing method used in forming seal patterns of LCD panels;

FIG. 4 illustrates a sealant dispenser in accordance with principles of the present invention;

FIG. 5 illustrates an enlarged view of the sealant dispenser in accordance with principles of the present invention; and

FIG. 6 illustrates a receiving container formed between a suction pipe and a vacuum pump.

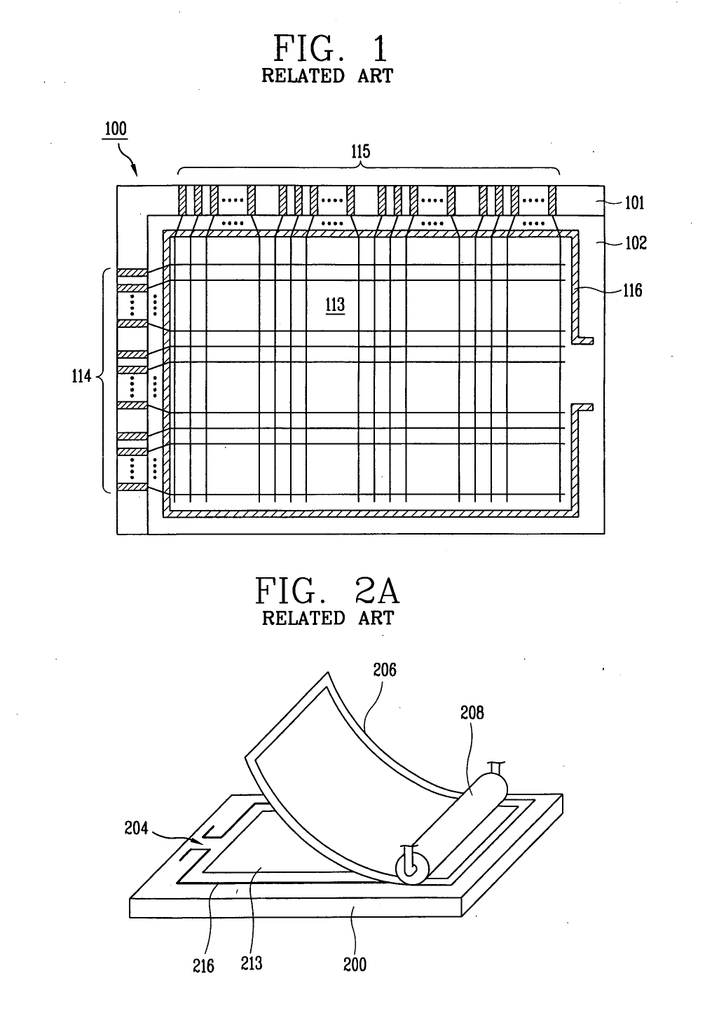

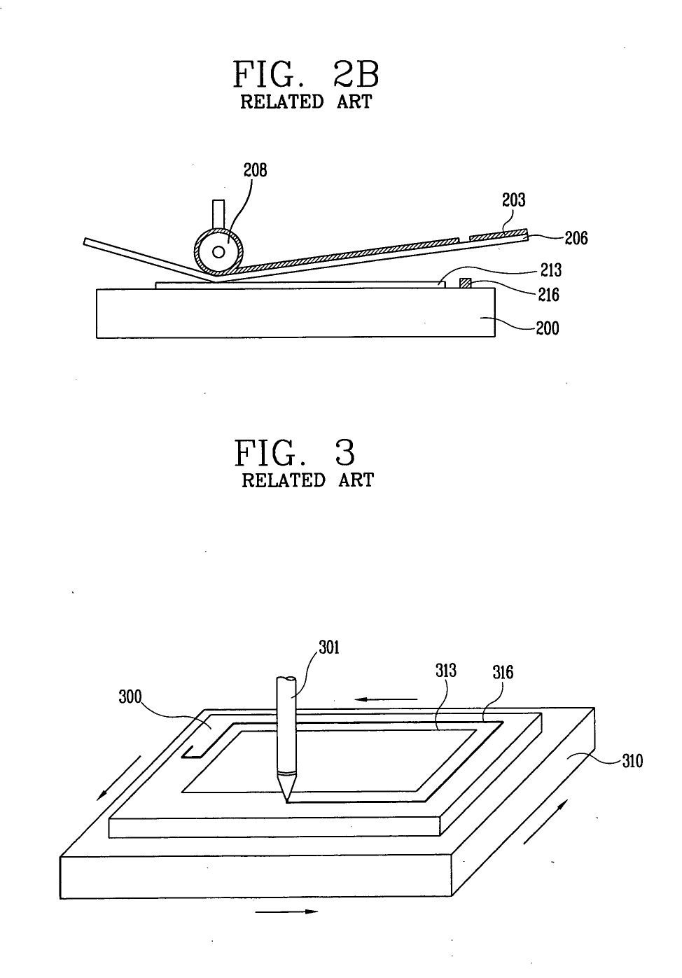

### DETAILED DESCRIPTION OF THE ILLUSTRATED EMBODIMENTS

Reference will now be made in detail to embodiments of the present invention, examples of which are illustrated in the accompanying drawings.

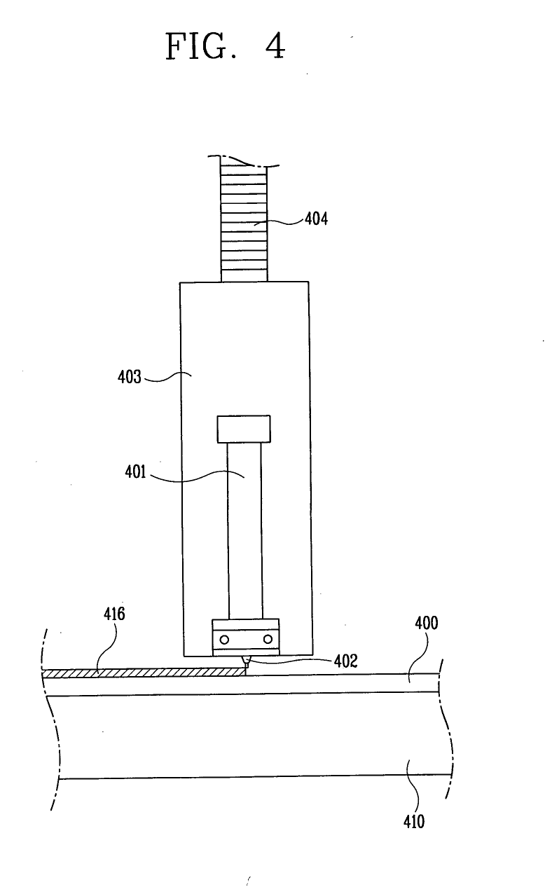

FIG. 4 illustrates a sealant dispenser in accordance with principles of the present invention.

Referring to FIG. 4, a sealant dispenser in accordance with principles of the present invention may, for example, be used to dispense sealant onto a substrate 400 supported, for example, by a table 410. In one aspect of the present invention, the sealant dispenser may include a syringe 401 and a nozzle 402. Sealant within the syringe 401 may be dispensed through the nozzle 402 onto the substrate 400, thereby forming a seal pattern 416. In another aspect of the present invention, the sealant dispenser may, for example, include a body 403 coupled to the syringe 401. In still another aspect of the present invention, the sealant dispenser may, for example, include a servo motor 404 for driving the body 403 along a vertical direction.

According to principles of the present invention, the substrate 400 may include a first base substrate formed, for example, of a material such as glass and having a plurality of thin film transistor array substrates fabricated thereon. In another aspect of the present invention, the substrate 400 may include a second base substrate formed, for example, of a material such as glass and having a plurality of color filter substrates fabricated thereon.

According to principles of the present invention, the body 403, coupled to the syringe 410, and/or the table 410, onto which the substrate 400 is loaded, may be horizontally driven to vary the relative positions of the nozzle 402 and substrate 400. In one aspect of the present invention, the entire seal pattern 416 may be formed by horizontally driving the body 403 while fixing the position of the table 410 and dispensing sealant through the nozzle 402. In another aspect of the present invention, the entire seal pattern 416 may be formed by horizontally driving the table 410 while fixing the position of the body 403 and dispensing sealant through the nozzle 402. In still another aspect of the present invention, the entire seal pattern 416 may be formed by horizontally driving the body 403 and the table 410 while dispensing sealant through the nozzle 402. In yet another aspect of the present invention, a first portion of the seal pattern 416 may be formed by horizontally driving only one of the table 410 and the body 403 (e.g., the table 410) while dispensing sealant through the nozzle 402 and a second portion of the seal pattern 416 may be formed by horizontally driving only one of the other of the table 410 and the body 403 (e.g., the body 403) while dispensing sealant through the nozzle 402. The first portion of the seal pattern 416 may, for example, include first and second opposing sides of the seal pattern 416. The second portion of the seal pattern 416 may, for example, include third and fourth opposing sides of the seal pattern, arranged between the first and second opposing sides. The length of the first and second opposing sides may, for example, be less than the length of the third and fourth opposing sides.

Although not shown, a cover may be provided at one end of the syringe 401 to expose the nozzle 402 and prevent foreign materials from accumulating on the substrate 400 if only the body 403 is horizontally driven and the position of the table 410 remains fixed.

According to principles of the present invention, multiple seal patterns 416 may be repeatedly dispensed onto the substrate 400 using the syringe 401. Accordingly, it is possible that sealant may gradually accumulate at the end of the nozzle 402 and, as discussed above, cause an excessive amount of sealant to be dispensed at start points of sealant dispensing paths used in forming the seal pattern 416. Thus, the principles of the present invention facilitate the removal (e.g., periodic removal) of the accumulated sealant material from the end of the nozzle 402 via a cleaning unit as exemplarily illustrated in FIG. 5.

FIG. 5 illustrates an enlarged view of the sealant dispenser in accordance with principles of the present invention.

Referring to FIG. 5, a cleaning unit 500 may be arranged operably proximate to the nozzle 402 of syringe 401 to substantially remove residual sealant 416A that accumulates at the end of the nozzle 402.

According to principles of the present invention, the cleaning unit 500 may, for example, includes a main body 510 and a suction pipe 520 disposed within the main body 510. In one aspect of the present invention, a first end of the suction pipe 520 may be substantially aligned with the nozzle 402 and a second end of the suction pipe 520 may be connected to a vacuum pump 530. In another aspect of the present invention, a supporting unit 511 may be provided on the main body 510 to define a predetermined space about the nozzle 402 when the first end of the suction pipe 520 is substantially aligned with the nozzle 402.

According to principles of the present invention, the residual sealant 416A accumulated at the end of the syringe 401 may be removed (e.g., periodically). In one aspect of the present invention, the residual sealant 416A may be removed after a predetermined number of seal patterns 416 have been formed, after a predetermined amount of sealant has been dispensed, after a predetermined amount of time has elapsed since a dispensing operation began, after a predetermined amount of residual sealant 416A has accumulated at the end of the nozzle 402, etc.

According to principles of the present invention, the sealant dispenser may be controlled, for example, by a micro computer. In one aspect of the present invention, the micro computer may drive at least one motor, causing the cleaning unit 500 and/or the body 403 to move such that the nozzle 402 and the first end of the suction pipe 520 are substantially aligned, whenever residual sealant 416A is to be removed from the end of the nozzle.

According to principles of the present invention, the residual liquid crystal material 416A may be periodically removed in accordance with a user input. For example, a user may measure an amount of residual sealant 416A that accumulates at the end of the nozzle 402 after individual ones of a plurality of seal patterns 416 are formed on the substrate 400. Subsequently, the user may equate some measured amount of residual sealant 416A to be an unacceptable amount of residual sealant 416A accumulated at the end of the nozzle 402. Accordingly, the user may input, to the micro computer, the number of seal patterns 416 that can be formed before an unacceptable amount of sealant 416A is accumulated at the end of the nozzle 402. As a result, the micro controller may control the sealant dispenser of the present invention to periodically remove residual sealant 416A accumulated on the nozzle 402 based on the number of seal patterns 416 formed, as input by the user.

Whenever the residual sealant 416A is to be substantially removed, a motor (not shown) may move the cleaning unit 500 toward the nozzle 402 of the syringe 401 such that the first end of the suction pipe 520 is substantially aligned with the nozzle 402. Alternatively, whenever the residual sealant 416A is to be substantially removed, a motor (not shown) may move the body 403, coupled to the syringe 401, toward cleaning unit 500 such that the first end of the suction pipe 520 is substantially aligned with the nozzle 402. Further, at least one motor may be used to simultaneously move both the body 403 and the cleaning unit 500 such that the first end of the suction pipe 520 is substantially aligned with the nozzle 402.

When the nozzle 402 and the first end of the suction pipe 520 are substantially aligned, the main body 510 and the supporting unit 511 define a predetermined space about the nozzle 402. Accordingly, when the vacuum pump 530 is driven, the suction pipe 520 transmits a suction force to the residual sealant 416A accumulated at the end of the nozzle 402. In turn, the transmitted suction force substantially removes the residual sealant 416A from the end of the nozzle 402 and transports the removed residual sealant 416A through the suction pipe 520.

In one aspect of the present invention, the sealant dispenser may, for example, include an opening and closing means for selectively blocking the flow of sealant from the syringe 401 to the nozzle 402. Accordingly, and prior to operating the cleaning unit 500 to remove the residual sealant 416A accumulated at the end of the nozzle 402, the opening and closing means may be operated to prevent sealant from flowing from the syringe 401 to the nozzle 402. After the cleaning unit 500 has removed residual sealant 416A accumulated at the nozzle 402, the opening and closing means may be operated to allow sealant to flow from the syringe 401 to the nozzle 402.

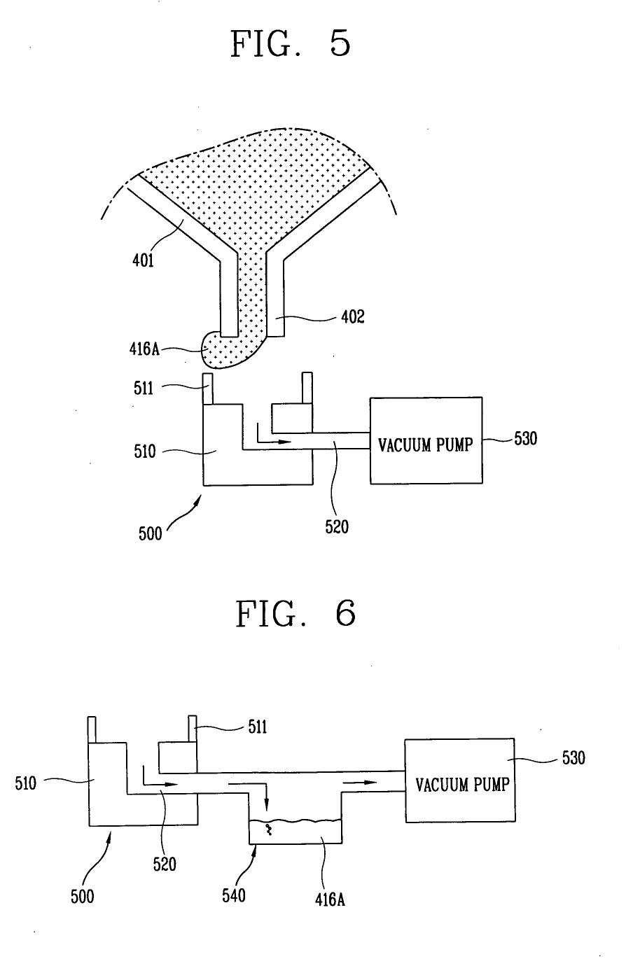

FIG. 6 illustrates a receiving container formed between a suction pipe and a vacuum pump.

Referring to FIG. 6, the cleaning unit 500 may, for example, include a receiving container 540 provided between the first and second ends of the suction pipe 520. In one aspect of the present invention, the receiving container 540 may be detachably connected between the first and second ends of the suction pipe 520. Upon driving the vacuum pump 530, the suction pipe 520 may transmit a suction force to the residual sealant 416A accumulated at the end of the nozzle 402. In turn, the transmitted suction force may substantially remove the residual sealant 416A from the end of the nozzle 402 and transport the removed residual sealant 416A through the suction pipe 520 and collected within the receiving container 540 via gravity. After a predetermined amount of residual sealant 416A is collected within the receiving container 540, the receiving container 540 may be detached from the suction pipe 520 and the collected residual sealant 416A may be removed from the receiving container 540.

As described above, a sealant dispenser according to principles of the present invention may include means for substantially removing residual sealant 416A accumulated at the end of a nozzle 402 of a syringe 401. In one aspect of the present invention, the residual sealant 416A may be removed via suction force generated and transmitted by a cleaning unit 500.

According to principles of the present invention, the aforementioned sealant from which the seal pattern 416 is formed may, for example, include a thermosetting sealant, an ultraviolet (UV) curing sealant, or the like, or mixtures thereof. In one aspect of the present invention, the sealant may have a viscosity of about 10,000 centipoise (cps) to about 500,000 cps. For example, when the sealant has a viscosity less than about 10,000 cps, the seal pattern 416 cannot maintain a predetermined thickness. When, for example, the sealant has a viscosity greater than about 500,000 cps, the residual sealant is difficult to remove the sealant by suction means.

It will be readily appreciated that the principles of the present invention may be readily extended to the formation of seal patterns for LCD panels having various shapes, sizes, and liquid crystal layers formed according to various methods. In one aspect of the present invention, liquid crystal layers of LCD panels contemplated as within the scope of the present invention may be formed via a vacuum injection method or a dispensing method.

According to the vacuum injection method, a separated, individual LCD panel having a liquid crystal injection hole may be arranged within a closed vacuum chamber maintained at a first pressure such that the pressure within the cell gap of the LCD panel is equal to the first pressure. Next, the liquid crystal injection hole be contacted by a reservoir of liquid crystal material arranged within the chamber. Subsequently, the pressure within the chamber may be increased to a second pressure to create a pressure difference between the pressure within the cell gap and the pressure within the chamber. Due to the pressure difference, liquid crystal material within the reservoir may be injected into the cell gap of the LCD panel via the liquid crystal injection hole. Once the cell gap is sufficiently sealed, the liquid crystal injection hole may be sealed, thereby forming a liquid crystal layer.

The liquid crystal injection hole discussed above with respect to the vacuum injection method constitutes a region of one side of the seal pattern that is opened. Accordingly, when forming the liquid crystal layer according to the vacuum injection method, a portion of the seal pattern may be opened to form the liquid crystal injection hole.

According to the dispensing method, liquid crystal material may be dispensed directly onto image display units of a plurality of thin film transistor array substrates formed on a first base substrate. Alternatively, liquid crystal material may be dispensed directly onto image display units of a plurality of color filter substrates formed on a second base substrate. Next, the dispensed liquid crystal material may be substantially uniformly spread over the entire image display unit of the thin film transistor array and color filter substrates upon apply pressure to bond the first and second base substrates together, thereby forming the liquid crystal layer. Upon bonding the first and second base substrates together, the thin film transistor array substrate and the color filter substrate may be substantially aligned. Next, the portions of the bonded first and second base substrates may be cut to separate the individual LCD panels.

Thus, the dispensing method described above involves dispensing liquid crystal material directly onto a substrate prior to bonding, rather than injecting liquid crystal material into a gap formed between bonded substrates. Accordingly, the seal pattern of an LCD panel having a liquid crystal layer formed according to the dispensing method may be closed to cover an entire peripheral edge of the image display unit, thereby preventing leakage of liquid crystal material outside the image display unit.

As described above, a sealant dispenser in accordance with principles of the present invention may substantially remove residual sealant accumulated at the end of a nozzle used in forming a seal pattern. Those skilled in the art will readily understand how to adapt the principles of the present invention in the fabrication of various models of LCD panels as well as many other types of flat panel displays that may be fabricated by bonding two substrates together (e.g., Electro Luminescent Display (ELD), a Field Emission Display (FED), a Plasma Display Panel (PDP) etc.). Further, while one aspect of the exemplary discussion provided above may illustrate the successive formation of a plurality of seal patterns by dispensing sealant from a single syringe, it will be readily appreciated that a plurality of seal patterns may be simultaneously fabricated by dispensing sealant from a plurality of syringes. Accordingly, the sealant dispenser of the present invention may be provided with one or more syringes. Moreover, the sealant dispenser of the present invention may be provided with one or more cleaning units, wherein one cleaning unit is provided for each nozzle or wherein at least one cleaning unit is provided for at least two nozzles.

As described above, the principles of the present invention provide the ability to substantially remove residual sealant accumulated at the end of a sealant dispenser, thereby preventing an excessive amount of sealant from being dispensed onto a substrate at start points along paths of the seal pattern. As described above, one aspect of the present invention contemplates removing the residual sealant via a suction force generated and transmitted by a cleaning unit. By preventing sealant from being excessively dispensed onto particular areas of a substrate, excessive spreading of the sealant pattern inside the image display unit may be substantially prevented, thereby avoiding contamination of liquid crystal material in the image display unit. Moreover, by preventing sealant from being excessively dispensed onto particular areas of a substrate, excessive spreading of the sealant pattern outside the image display unit may be substantially prevented, thereby preventing a subsequent cutting process from being obstructed. Accordingly, the principles of the present invention may substantially eliminate picture quality degradation and cutting inefficiencies caused by unacceptable spreading of sealant during a substrate bonding process, thereby improving both the yield and productivity of an LCD panel fabricating process.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A sealant dispenser, comprising:
at least one syringe that contains sealant;
a nozzle in fluid communication with the at least one syringe, wherein sealant contained by the at least one syringe is dispensable onto a substrate through a lower portion of the nozzle and accumulatable at the lower portion of the nozzle; and
at least one cleaning unit that, when operably proximate to the lower portion of the nozzle, removes residual sealant accumulated at the lower portion of the nozzle.

2. The sealant dispenser of claim 1, further comprising at least one motor coupled to at least one of the at least one cleaning unit and the at least one syringe, wherein the at least one motor moves and aligns the cleaning unit and lower portion of the nozzle.

3. The sealant dispenser of claim 1, further comprising a motor coupled to the at least one cleaning unit, wherein the motor moves and aligns the cleaning unit with the lower portion of the at least one nozzle.

4. The sealant dispenser of claim 1, further comprising a motor coupled to the at least one syringe, wherein the motor moves the syringe to align the lower portion of the nozzle with an upper portion of the at least one cleaning unit.

5. The sealant dispenser of claim 1, further comprising opening and closing means arranged between the at least one syringe and the nozzle for selectively placing the nozzle and the syringe in fluid communication.

6. The sealant dispenser of claim 1, wherein the at least one cleaning unit comprises:
a main body having an upper portion;
a suction pipe coupled to the main body, the suction pipe having a first end and a second end, the first end of the suction pipe being disposed at the upper portion of the main body; and
a vacuum pump connected to the second end of the suction pipe.

7. The sealant dispenser of claim 6, further comprising a supporting unit on the upper portion of the main body, wherein supporting unit and the upper portion of the main body define a predetermined space about the lower portion of the nozzle when the cleaning unit is operably proximate to the lower portion of the nozzle.

8. The sealant dispenser of claim 6, wherein the supporting unit is laterally spaced apart from the first end of the suction pipe.

9. The sealant dispenser of claim 6, further comprising a container connected in fluid communication between the first and second ends of the suction pipe.

10. The sealant dispenser of claim 9, wherein the receiving container is detachably connected to the suction pipe.

11. The sealant dispenser of claim 1, wherein the sealant includes at least one of a thermosetting sealant and an ultraviolet (UV) curing sealant.

12. The sealant dispenser of claim 1, wherein the sealant has a viscosity of about 10,000 centipoises (cps) to about 500,000 cps.

13. A method of forming a seal pattern on a substrate, comprising:
dispensing sealant through the lower portion of at least one nozzle and onto the substrate;
moving at least one of the nozzle and the substrate during the dispensing to form at least one seal pattern on the substrate;
accumulating sealant at the lower portion of the nozzle during the dispensing; and
removing the accumulated sealant from the lower portion of the nozzle.

14. The method of claim 13, wherein at least one seal pattern is formed in a closed shape.

15. The method of claim 13, wherein at least one seal pattern is formed in an open shape.

16. The method of claim 13, further comprising, before removing the accumulated sealant, stopping the dispensing of the sealant.

17. The method of claim 13, further comprising removing the accumulated sealant by a suction force.

18. A method of removing sealant accumulated at lower portion of a nozzle of a sealant dispenser, comprising:
determining whether a predetermined amount of sealant is accumulated at the lower portion of the nozzle;
generating a suction force if it is determined that a predetermined amount of sealant is accumulated at the lower portion of the nozzle; and
transmitting the generated suction force to the accumulated sealant to substantially remove the accumulated sealant from the nozzle.

19. The method of claim 18, wherein the transmitting includes:
aligning a first end of a suction pipe with the lower portion of the nozzle; and
connecting a second end of the suction pipe with a vacuum pump.

20. The method of claim 18, further comprising collecting the removed sealant.
